(19) United States
(12) Patent Application Publication
(10) Pub. No.: US 2011/0090496 A1
(43) Pub. Date: Apr. 21, 2011

(54) DOWNHOLE MONITORING WITH DISTRIBUTED OPTICAL DENSITY, TEMPERATURE AND/OR STRAIN SENSING

(75) Inventors: Etienne M. SAMSON, Houston, TX (US); John L. MAIDA, JR., Houston, TX (US)

(73) Assignee: HALLIBURTON ENERGY SERVICES, INC., Houston, TX (US)

(21) Appl. No.: 12/603,299

(22) Filed: Oct. 21, 2009

(51) Int. Cl. G01J 3/44

(52) U.S. Cl. 356/301

(57) ABSTRACT

Distributed density, temperature and/or strain sensing is utilized for downhole monitoring. A method and system for monitoring a rapidly changing parameter in a well includes: detecting gain-based stimulated Brillouin backscattering due to light transmitted through at least one optical waveguide installed in the well, the Brillouin backscattering being dependent upon temperature and strain experienced by the waveguide in the well. The method can include measuring at least one of temperature and strain in the well, with the measurement being performed separately from the step of detecting Brillouin backscattering.

### BACKGROUND

The present disclosure relates generally to equipment utilized and operations performed in conjunction with a subterranean well and, in an embodiment described herein, more particularly provides for downhole monitoring with distributed optical density, temperature and/or strain sensing.

It is known to monitor distributed temperature along a wellbore, in order to detect movement of fluid along the wellbore. However, prior methods (such as DTS) have been based on detecting Raman backscattering in an optical fiber installed in the wellbore. Such methods generally produce relatively slow effective sample rates, thereby providing relatively low temporal resolution, and preventing detection of sharp (fast) thermal or strain transients.

In order to monitor fluid disturbances in real time, so that changes (such as, in stimulation treatments, etc.) can be made “on the fly” to maximize treatment effectiveness, much faster effective sample rates are required. Therefore, it will be appreciated that improvements are needed in the art of downhole monitoring.

### SUMMARY

In carrying out the principles of the present disclosure, systems and methods are provided which bring improvements to the art of downhole monitoring. Examples are described below in which gain-based stimulated Brillouin backscattering is detected in a method of monitoring fast temperature and strain events (for example, due to fluid movement) in a well.

In one aspect, a method of monitoring a parameter in a well is provided. The method includes the steps of: detecting stimulated Brillouin backscattering due to light transmitted through at least one optical waveguide installed in the well, the Brillouin backscattering being dependent upon temperature and strain experienced by the waveguide in the well.

The method can include measurement of temperature or strain in the well. The measurement of temperature or strain is preferably separate from the step of detecting the stimulated Brillouin backscattering.

The method can then utilize “on the fly” calibration of the Brillouin traces using the separate measurement technique as reference.

These and other features, advantages and benefits will become apparent to one of ordinary skill in the art upon careful consideration of the detailed description of representative embodiments of the disclosure hereinbelow and the accompanying drawings, in which similar elements are indicated in the various figures using the same reference numbers.

### BRIEF DESCRIPTION OF THE DRAWINGS

FIG. 1 is a schematic view of a well system and method embodying principles of the present disclosure.

FIGS. 2 & 3 are schematic cross-sectional views of optical waveguide cables which may be used in the system and method of FIG. 1.

FIGS. 4-6 are schematic elevational views of sensors which may be used in the system and method of FIG. 1.

FIG. 7 is a graph of optical intensity versus wavelength for various forms of optical backscattering.

FIG. 8 is a schematic view of optical equipment which may be used in the system and method of FIG. 1.

FIG. 9 is a graph of temperature versus depth along a wellbore, showing temperature profiles at spaced time intervals.

### DETAILED DESCRIPTION

Fluid movement in a well can be detected by observing the effect(s) of changes in the well due to the fluid movement. For example, a fluid having a different temperature from the well environment can be pumped into the well, and the effects of the temperature change in the well can be detected as an indication of the presence of the fluid. With an optical waveguide installed in the well, the temperature change can be detected at any position along the waveguide. Various techniques can be used to detect not only temperature change, but also, or alternatively, changes in strain, density, etc., as indications of the presence and position of the fluid at any point in time.

For underground oil & gas, geothermal, conformance, waste disposal, and carbon capture and storage (CCS) operations, monitoring fast temperature events (like fluid movement) within and along the wellbore is useful. Specifically for wellbore stimulation activities (e.g., chemical injection, acidizing and hydraulic fracture treatments), it is useful to know the fluid movement (displacement) within and along the wellbore to determine the volume distribution of the injected fluid across the target interval(s), and to identify possible undesired injection out of the target zone. For injection operations, the velocity of the fluid proportionally decreases as fluid exits at various points along the wellbore.

This disclosure describes an example where this technique is used for measuring the velocity of the fluid in and along the wellbore in real time. The technique utilizes the differences in the fluid properties (if different fluids are injected) or induced fluid property changes by adding chemicals, materials, heating/cooling or mechanical devices to form “tracers” to provide static and dynamic density, strain and/or temperature signatures.

One advantage of these techniques over other methods is that we are now able to measure the disturbances over much shorter periods of time (less than a few seconds versus tens of seconds) allowing us to both monitor much higher injection rates (and corresponding fluid velocities) and to obtain more detailed resolution of the fluid distribution. A preferred method for measuring static strain/temperature disturbances is Stimulated Brillouin backscatter where the traces are recalibrated “on the fly” to isolate strain from temperature.

This information can be used in evaluating the effectiveness of the injection operation through understanding the fluid distribution. Using this information in real time during injection, a pumping procedure can be modified or corrected in order to maximize its effectiveness. The information may also be used in planning future injection operations in the same or different wellbores.

The principles of this disclosure can also be applied to producing wells by introducing strain and/or temperature “tracers” or events downhole and monitoring their movement as they are produced up the wellbore, identifying velocity increases at fluid contribution points along the wellbore. The velocity will increase as fluid enters the wellbore.

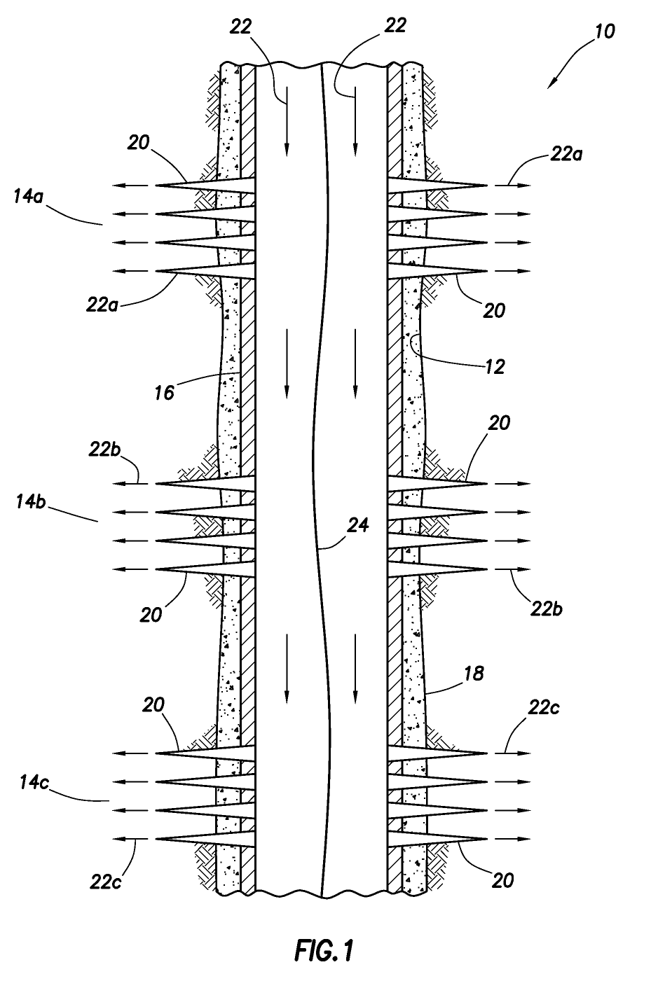

Representatively illustrated in FIG. 1 is a well system 10 and associated method which embody principles of the present disclosure. As depicted in FIG. 1, a wellbore 12 has been drilled, such that it intersects several subterranean formation zones 14a-c. The wellbore 12 has been lined with casing 16 and cement 18, and perforations 20 provide for fluid flow between the interior of the casing and the zones 14a-c.

At this point it should be noted that the system 10 as illustrated in FIG. 1 is merely one example of a wide variety of well systems which can utilize the principles described in this disclosure, and so it will be appreciated that those principles are not limited at all by the details of the example of the system 10 and associated method depicted in FIG. 1 and described herein. For example, although only three zones 14a-c are depicted in FIG. 1, any number of zones (including just one) may be intersected by, and in fluid communication with, the wellbore 12. As another example, it is not necessary for the wellbore 12 to be cased, since the wellbore could instead be uncased or open hole, at least in the portion of the wellbore intersecting the zones 14a-c. The zonal isolation provided by cement 18 could in other examples be provided using different forms of packers, etc.

As yet another example, fluid 22 is depicted in FIG. 1 as being injected into the well via the wellbore 12, with one portion 22a entering the zone 14a, another portion 22b entering the zone 14b, and another portion 22c entering the zone 14c. This may be the case in stimulation, conformance, storage, geothermal, disposal and/or other operations in which fluid is injected into a wellbore.

However, in other operations (such as production, etc.) the direction of flow of the fluid 22 could be the reverse of that depicted in FIG. 1. Thus, the fluid portions 22a-c could instead be received from the respective zones 14a-c into the wellbore 12.

In other situations, fluid could be injected into one section of a well, and fluid could be received from the same or another section of the well, either simultaneously or alternately. Thus, it will be appreciated that a large variety of operations are possible in which the movement of fluid in a well could be monitored.

In order to provide for monitoring movement of the fluid 22, the system 10 and associated method utilize an optical waveguide cable 24 installed in the well. The cable 24 includes one or more optical waveguides (such as optical fiber(s), optical ribbon(s), multi-core fibers and holey fibers, as well as any other desired communication or power lines, etc.). As described more fully below, the optical waveguide(s) are useful in detecting temperature, strain, vibration and/or other parameters distributed along the wellbore 12 as indications of movement of the fluid 22 along the wellbore.

Although the cable 24 is depicted in FIG. 1 as being installed by itself within the casing 16, this is but one example of a wide variety of possible ways in which the cable may be installed in the well. The cable 24 could instead be positioned in a sidewall of the casing 16, inside of a tubing which is positioned inside or outside of the casing or a tubular string within the casing, in the cement 18, or otherwise positioned in the well.

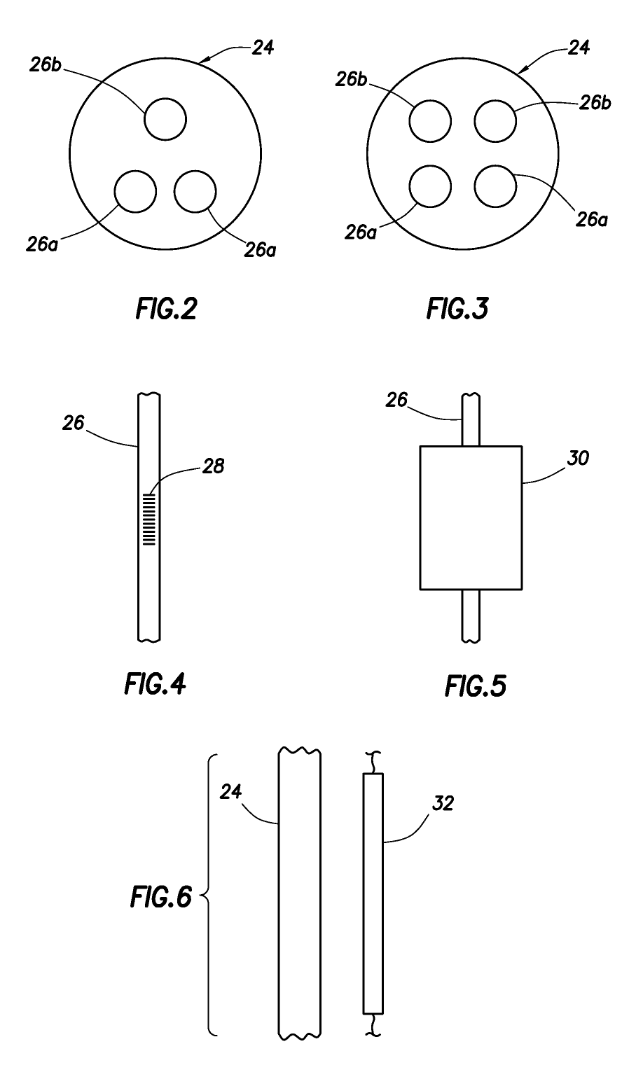

Referring additionally now to FIGS. 2 & 3, enlarged scale cross-sectional views of different configurations of the cable 24 are representatively illustrated. The cable 24 of FIG. 2 includes three optical waveguides 26, whereas the cable of FIG. 3 includes four optical waveguides. However, any number of optical waveguides 26 (including one) may be used in the cable 24, as desired.

The cable 24 could also include any other types of lines (such as electrical lines, hydraulic lines, etc.) for communication, power, etc., and other components (such as reinforcement, protective coverings, etc.), if desired. The cables 24 of FIGS. 2 & 3 are merely two examples of a wide variety of different cables which may be used in systems and methods embodying the principles of this disclosure.

The cable 24 of FIG. 2 includes at least two single mode optical waveguides 26a and at least one multi-mode optical waveguide 26b. The single mode waveguides 26a are preferably optically connected to each other at the bottom of the cable 24, for example, using a conventional looped fiber or mini-bend. In other examples, more than one multi-mode waveguide could be used, and less than two single mode waveguides could be used (e.g., with a mirror on the end of the single mode waveguide for a pump light to stimulate a probe light). These elements are well known to those skilled in the art, and so are not described further herein.

In one example, a stimulated Brillouin backscattering detector is connected to the single mode optical waveguides 26a for detecting Stimulated Brillouin backscattering due to light transmitted through the waveguides. A Raman backscattering detector is connected to the multi-mode optical waveguide 26b for detecting Raman backscattering due to light transmitted through the waveguide. In other examples, the Raman backscattering detector may be connected to the single mode optical waveguides 26a.

The cable 24 of FIG. 3 includes two single mode optical waveguides 26a and two multi-mode optical waveguides 26b. A stimulated Brillouin backscattering detector is preferably connected to the single mode optical waveguides 26a for detecting Brillouin backscattering due to light transmitted through the waveguides. A Raman backscattering detector is preferably connected to the multi-mode optical waveguides 26b for detecting Raman backscattering due to light transmitted through the waveguides.

However, it should be understood that any optical detectors and any combination of optical detecting equipment may be connected to the optical waveguides 26a,b in keeping with the principles of this disclosure. For example, a Rayleigh backscattering detector, an interferometer, or any other types of optical instruments may be used. As another example, a Raman backscattering detector may be connected to the single mode optical waveguides 26a.

Referring additionally now to FIG. 4, any of the optical waveguides 26 (which may be single mode or multi-mode waveguide(s)) may be provided with one or more Bragg gratings 28. As is well known to those skilled in the art, a Bragg grating 28 can be used to detect strain and a change in optical path length along the waveguide 26.

A Bragg grating 28 can serve as a single point strain sensor, and multiple Bragg gratings may be spaced apart along the waveguide 26, in order to sense strain at various points along the waveguide. An interferometer may be connected to the waveguide 26 to detect wavelength and/or phase shift in light reflected back from the Bragg grating 28.

Since a change in temperature will also cause a change in optical path length along the waveguide 26, the Bragg grating 28 can also, or alternatively, be used as a temperature sensor to sense temperature along the waveguide. If multiple Bragg gratings 28 are spaced out along the waveguide 26, then a temperature profile along the waveguide 26 can be detected using the Bragg gratings.

Referring additionally now to FIG. 5, an optical sensor 30 may be positioned on any of the optical waveguides 26. The sensor 30 may be used to measure temperature, strain or any other parameter or combination of parameters along the waveguide. Multiple sensors 30 may be distributed along the length of the waveguide 26, in order to measure the parameter(s) as distributed along the waveguide.

Any type of optical sensor 30 may be used for measuring any parameter in the system 10. For example, a Bragg grating 28, a polarimetric sensor, an interferometric sensor, and/or any other type of sensor may be used in keeping with the principles of this disclosure.

Referring additionally now to FIG. 6, another sensor 32, such as an electronic sensor, may be used in conjunction with the cable 24 to sense parameters in the well. The sensor 32 could, for example, comprise an electronic sensor for sensing one or more of temperature, strain, vibration, acoustic energy, or any other parameter. Multiple sensors 32 may be distributed in the well, for example, to measure the parameter(s) as distributed along the wellbore 12.

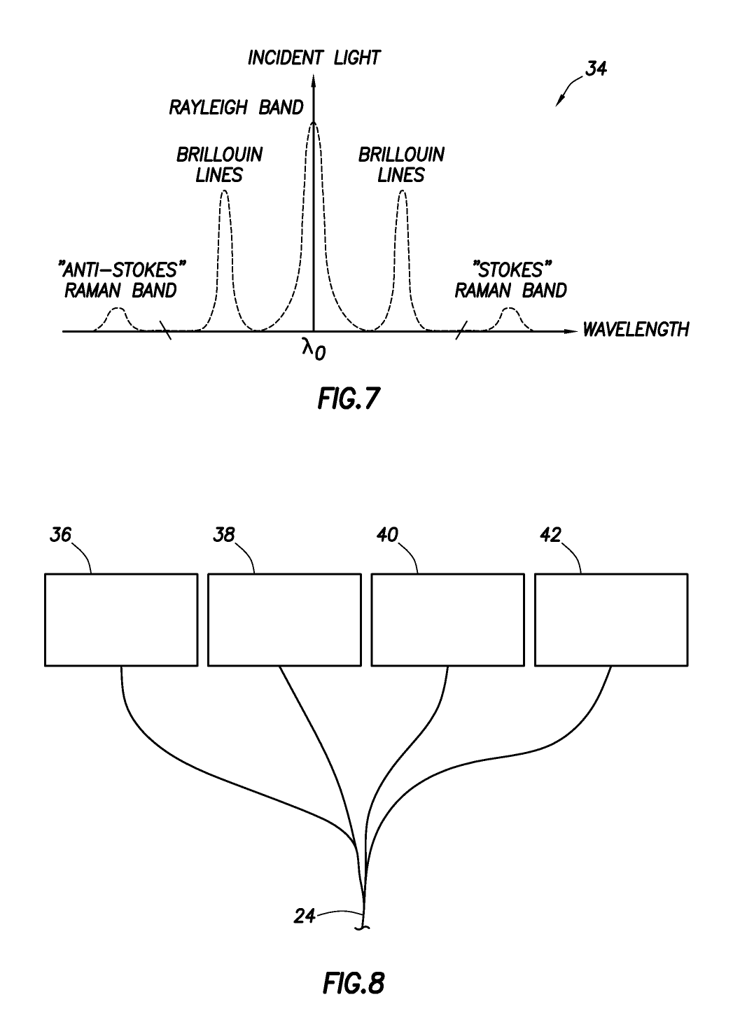

Referring additionally now to FIG. 7, a graph 34 of various forms of optical backscattering due to light being transmitted through an optical waveguide is representatively illustrated. The graph 34 shows relative optical intensity of the various forms of backscattering versus wavelength. At the center of the abscissa is the wavelength λ₀ of the light initially launched into the waveguide.

Rayleigh backscattering has the highest intensity and is centered at the wavelength λ₀. Rayleigh backscattering is due to microscopic inhomogeneities of refractive index in the waveguide material matrix.

Note that Raman backscattering (which is due to thermal excited molecular vibration known as optical phonons) has an intensity which varies with temperature T, whereas Brillouin backscattering (which is due to thermal excited acoustic waves known as acoustic phonons) has a wavelength which varies with both temperature T and strain ε. Detection of Raman backscattering is typically used in distributed temperature sensing (DTS) systems, due in large part to its direct relationship between temperature T and intensity, and almost negligent sensitivity to strain ε.

However, the Raman backscattering intensity is generally less than that of Rayleigh or Brillouin backscattering, giving it a correspondingly lower signal-to-noise ratio. Consequently, it is common practice to sample the Raman backscattering many times and digitally average the readings, which results in an effective sample rate of from tens of seconds to several minutes, depending on the signal-to-noise ratio, fiber length and desired accuracy. This effective sample rate is too slow to accurately track fast moving fluid in a wellbore.

In contrast to conventional practice, the system 10 and associated method use detection of stimulated Brillouin backscattering to increase the effective sample rate to a matter of a few seconds, which is very useful in tracking fluid displacement along a wellbore, since fluid can be flowed a large distance in a short period of time. Utilizing the concepts provided by this disclosure, resolution and accuracy equivalent to that of Raman backscattering detection is achieved, while significantly reducing the effective sample rate.

For intense beams (e.g. laser light) traveling in a medium such as an optical fiber, the variations in the electric field of the beam itself may produce acoustic vibrations in the medium via electrostriction. The beam may undergo Brillouin scattering from these vibrations, usually in an opposite direction to the incoming beam, a phenomenon known as stimulated Brillouin scattering (SBS).

Brillouin backscattering detection measures a frequency shift (Brillouin frequency shift, BFS), with the frequency shift being sensitive to localized density ρ of the waveguide 26. Density ρ is affected by two parameters: strain ε and temperature T. Thus:

BFS(ρ)=BFS(ε)+BFS(T) (1)

In order to isolate the BFS due to either strain or temperature change, the other parameter can be separately measured. Preferably, the other parameter is measured at multiple points along the waveguide 26 at regular time intervals, and these measurements are used to refine or recalibrate the determinations of BFS for the parameter of interest.

For example, if it is desired to detect temperature distribution along the wellbore 12 using Brillouin backscattering detection, then the total BFS(ρ) can be detected by a suitable optical instrument connected to the waveguide 26, and a separate measurement of strain along the waveguide can be made (e.g., using Bragg gratings 28, other optical sensors 30 or other types of sensors 32, including Raman or Rayleigh backscattering detection instruments, long period gratings, chiral long period gratings, polarization maintaining fibers, Fabry-Perot or other interferometers, including Sagnac, Michelson, and Mach-Zehnder types).

The properties of the waveguide 26 being known, the BFS(ε) can be subtracted from the detected BFS(ρ) to yield BFS(T), thereby enabling the distributed temperature along the waveguide to be readily calculated. Note that it is not necessary to perform the intermediate calculations of BFS(ε) and BFS(T), since the response (density change) of the waveguide 26 material due to strain and temperature changes are known properties of the material.

Of course, if it is desired to detect strain distribution along the wellbore 12 using Brillouin backscattering detection, then the separate measurements would be of temperature along the waveguide 26 (e.g., using any of the sensors discussed herein), and those measurements would be used to separate out the effect of temperature change on the density change of the waveguide. Thus, distributed strain along the waveguide 26 can also be readily determined using the principles of this disclosure.

However, it should be understood that it is not necessary to separate out either of the BFS(ε) and BFS(T) from the detected BFS(ρ). Instead, a monitoring system can simply track a disturbance or anomaly as it moves in the wellbore 12 by observing the detected BFS due to density change in the optical waveguide 26. Density changes in the waveguide 26 can be caused by various occurrences (such as temperature change, fluid friction elongating or ballooning a tubular, etc.). By detecting the density change in the optical waveguide 26, the presence and location of the cause of the density change can be readily determined.

Therefore, it will be appreciated that the above-described method can accelerate the sample rate of DTS measurements, while maintaining resolution and accuracy, as compared to prior methods of detecting Raman backscattering. This enables: (1) tracking a moving temperature anomaly in the fluid 22 with better temporal resolution as compared to methods utilizing detection of Raman backscattering alone, (2) detection of short duration temperature changes (spikes, drop-offs, etc.) which would otherwise be lost or minimized in the long duration averaging used in Raman backscattering detection, especially if the temperature change is displacing along the wellbore 12, and (3) tracking of strain simultaneous with tracking of temperature, which can aid in detection of events which produce little or no temperature change.

A preferred embodiment utilizes a cable 24 with at least two single mode and one multi-mode optical waveguide 26a,b as depicted in FIG. 2. The single mode waveguides 26a would be connected together at their bottom ends using a looped fiber or mini-bend. A stimulated Brillouin backscattering detector 36 (see FIG. 8), looking at Brillouin gain, would be connected to the single mode waveguides 26a of the cable 24 (for example, at the surface or another remote location), collecting readings at a relatively fast sample rate of ˜1-5 seconds.

A Raman backscattering detector 38 could be connected to the multi-mode waveguide 26b of the cable 24 and used to collect DTS temperature profiles at a much slower sample rate. Periodically, the Raman-based temperature profile would be used to recalibrate or refine the Brillouin-based temperature/strain profile along the wellbore 12. In another embodiment, the Raman backscattering detector 38 could be connected to multiple multi-mode waveguides 26b, as in the cable 24 depicted in FIG. 3.

In yet another embodiment, a coherent phase Rayleigh backscattering detector 40 may be connected to the optical cable 24, and/or an interferometer 42 may be connected to the cable, for accomplishing the separate measurement of parameters in the well. The detectors 36, 38, 40, 42 are not necessarily separate instruments. It should be understood that any technique for measuring the parameters in the well may be used, in keeping with the principles of this disclosure.

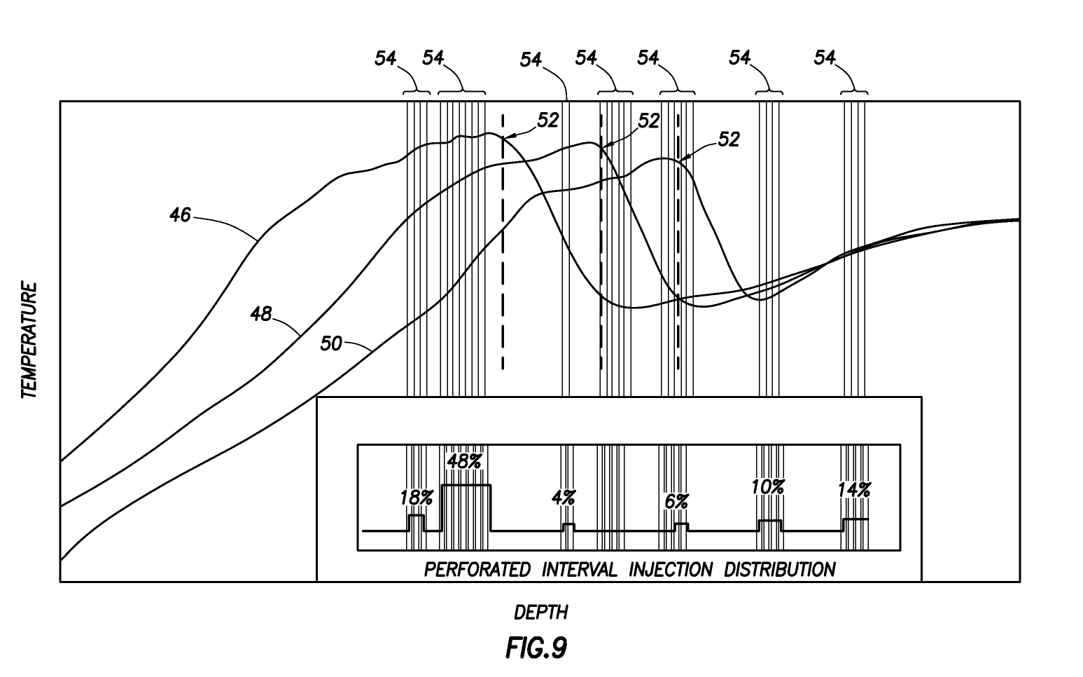

Referring additionally now to FIG. 9, an example of how a thermal tracer moving in a wellbore can be monitored utilizing the principles of this disclosure is representatively illustrated. In this example, the fluid 22 is pumped in the wellbore 12 and is monitored using the optical waveguide cable 24. By observing temperature traces 46, 48, 50, one can monitor the temperature of the well changing toward the temperature of the fluid 22 being pumped.

Initially, when the system 10 is at temperature equilibrium (so that the temperature is fairly constant along the wellbore 12), the fluid 22 which has a temperature different from that in the wellbore 12 is introduced (e.g., by pumping it into the wellbore). The fluid 22 will produce a temperature tracer (an anomaly, either hotter or colder than the wellbore environment) which will be visible on a fiber optic distributed temperature trace, such as the traces 46, 48, 50 depicted in FIG. 9.

Each subsequent trace will show the temperature anomaly 52 but at a different location depending on the direction of the fluid 22 flow and the flow rate. Knowing the time interval between traces 46, 48, 50 and the difference in position (depth) between the traces, the flow rate at each time between the traces can be readily determined (volumetric flow rate=flow area*(Δ time/Δ distance)).

As the temperature tracer moves past perforated intervals 54, a determination may be made as to whether the rate of displacement of the temperature tracer is getting shorter. A shorter displacement between two traces would indicate that fluid 22 flowed into the corresponding perforated interval 54, and that the flow rate in the wellbore is reducing.

In FIG. 9, the calculated injection distribution into each perforated interval 54 is representatively depicted as an inset to the graph of temperature versus depth. Note that the percentage of the flow injected into each of the perforated intervals 54 can be readily determined.

The principles of this disclosure provide for real time (approximately every 1-5 seconds) determination of flow rate and injection distribution. Thus, modifications and corrections to the injection operation can be made “on the fly” while the injection operation progresses and while the fluid 22 is being pumped, thereby enabling an operator to more accurately conform the actual injection distribution to a desired injection distribution.

Similarly, instead of tracking the temperature anomaly 52 along the wellbore 12, a strain anomaly or density anomaly can also be tracked. As discussed above, the Brillouin frequency shift is sensitive to the localized density ρ of the waveguide 26, and so density changes along the waveguide can be readily monitored.

The density ρ is affected by strain ε and temperature T, and the BFS due to either strain or temperature change can be determined by separately measuring the other parameter. However, this determination of the BFS due to either strain or temperature change, and separate measuring the other parameter, is not necessary in keeping with the principles of this disclosure, since the detected density change can readily indicate the presence and location of an anomaly.

It may now be fully appreciated that the above disclosure provides many advancements to the art of monitoring fluid movement in a well. Fluid movement can be detected and monitored much more accurately, as compared to prior methods, using the principles described above.

The above disclosure describes a method of monitoring a parameter in a well, with the method including detecting stimulated Brillouin backscattering based on gain due to light transmitted through at least one optical waveguide 26 installed in the well. The Brillouin backscattering is dependent upon temperature and strain experienced by the waveguide 26 in the well.

The method may include the step of measuring temperature or strain in the well, with the measuring step being performed separately from the step of detecting stimulated Brillouin backscattering. The stimulated Brillouin backscattering is preferably not detected in the step of measuring temperature or strain in the well.

The monitored parameter may comprise distributed strain, in which case the measuring step includes measuring temperature in the well. The measured temperature is utilized to calibrate the detected Brillouin backscattering, thereby separating the distributed strain from distributed temperature in the well.

The monitored parameter may comprise distributed temperature, in which case the measuring step includes measuring strain in the well. The measured strain is utilized to calibrate the detected Brillouin backscattering, thereby separating the distributed strain from distributed temperature in the well.

The measuring step may include measuring temperature by detecting Raman backscattering. The Raman backscattering may be indicative of distributed temperature in the well.

The measuring step may include detecting Rayleigh backscattering loss.

The measuring step may include utilizing at least one Bragg grating 28 which detects the temperature or strain in the well.

The measuring step may include utilizing at least one electronic sensor 30 which detects the temperature or strain in the well.

Also described by the above disclosure is a system 10 for monitoring a parameter in a well. The system 10 includes an optical waveguide 26 installed in the well, and a stimulated Brillouin backscattering detector 36 which detects stimulated Brillouin backscattering based on gain due to light transmitted through the waveguide 26. The Brillouin backscattering is dependent upon temperature and strain experienced by the waveguide 26 in the well.

The system 10 may include an instrument (such as detectors 38, 40, interferometer 42, etc.) which measures temperature or strain in the well. The instrument may measure the temperature or strain separately from the stimulated Brillouin backscattering detector 36. The stimulated Brillouin backscattering may not be detected by the instrument.

The parameter being monitored may comprise distributed strain, in which case the instrument measures temperature in the well, and the detected Brillouin backscattering is calibrated based on the measured temperature. In this manner, the distributed strain can be separated from distributed temperature in the well.

The monitored parameter may comprise distributed temperature, in which case the instrument measures strain in the well, and the detected Brillouin backscattering is calibrated based on the measured strain. In this manner, the distributed strain can be separated from distributed temperature in the well.

The instrument may comprise a Raman backscattering detector 38. The Raman backscattering detected by the Raman backscattering detector 38 may be indicative of distributed temperature in the well.

The instrument may detect Rayleigh backscattering, in which case the instrument may comprise a coherent Rayleigh backscattering detector 40.

The instrument may be operatively connected to at least one Bragg grating 28 which detects the temperature or strain in the well. The instrument may be operatively connected to at least one electronic sensor 32 which detects the temperature or strain in the well.

It is to be understood that the various embodiments of the present disclosure described herein may be utilized in various orientations, such as inclined, inverted, horizontal, vertical, etc., and in various configurations, without departing from the principles of the present disclosure. The embodiments are described merely as examples of useful applications of the principles of the disclosure, which is not limited to any specific details of these embodiments.

In the above description of the representative embodiments of the disclosure, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore.

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of the present disclosure. Accordingly, the foregoing detailed description is to be clearly understood as being given by way of illustration and example only, the spirit and scope of the present invention being limited solely by the appended claims and their equivalents.

What is claimed is:

1. A method of monitoring a rapidly changing parameter in a well, the method comprising:
detecting stimulated Brillouin backscattering based on gain due to light transmitted through at least one optical waveguide installed in the well, the Brillouin backscattering being dependent upon temperature and strain experienced by the waveguide in the well.

2. The method of claim 1, further comprising the step of measuring temperature or strain in the well, the measuring step being performed separately from the step of detecting stimulated Brillouin backscattering.

3. The method of claim 2, wherein the stimulated Brillouin backscattering is not detected in the step of measuring temperature or strain in the well.

4. The method of claim 2, wherein the parameter comprises distributed strain, wherein the measuring step comprises measuring temperature in the well, and further comprising the step of utilizing the measured temperature to calibrate the detected Brillouin backscattering, thereby separating the distributed strain from distributed temperature in the well.

5. The method of claim 2, wherein the parameter comprises distributed temperature, wherein the measuring step comprises measuring strain in the well, and further comprising the step of utilizing the measured strain to calibrate the detected Brillouin backscattering, thereby separating the distributed strain from distributed temperature in the well.

6. The method of claim 2, wherein the measuring step further comprises measuring temperature by detecting Raman backscattering.

7. The method of claim 6, wherein the Raman backscattering is indicative of distributed temperature in the well.

8. The method of claim 2, wherein the measuring step further comprises detecting Rayleigh backscattering to determine temperature distribution or anomalies.

9. The method of claim 2, wherein the measuring step further comprises utilizing at least one Bragg grating which detects the temperature or strain in the well.

10. The method of claim 2, wherein the measuring step further comprises utilizing at least one electronic sensor which detects the temperature or strain in the well.

11. A system for monitoring a parameter in a well, the system comprising:
an optical waveguide installed in the well; and
a stimulated Brillouin backscattering detector which detects stimulated Brillouin backscattering based on gain due to light transmitted through the waveguide, the Brillouin backscattering being dependent upon temperature and strain experienced by the waveguide in the well.

12. The system of claim 11, further comprising an instrument which measures temperature or strain in the well, and wherein the instrument measures the temperature or strain separately from the stimulated Brillouin backscattering detector.

13. The system of claim 12, wherein the stimulated Brillouin backscattering is not detected by the instrument.

14. The system of claim 12, wherein the parameter comprises distributed strain, wherein the instrument measures temperature in the well, and the detected Brillouin backscattering is calibrated based on the measured temperature, whereby the distributed strain is separated from distributed temperature in the well.

15. The system of claim 12, wherein the parameter comprises distributed temperature, wherein the instrument measures strain in the well, and the detected Brillouin backscattering is calibrated based on the measured strain, whereby the distributed strain is separated from distributed temperature in the well.

16. The system of claim 12, wherein the instrument comprises a Raman backscattering detector.

17. The system of claim 16, wherein Raman backscattering detected by the Raman backscattering detector is indicative of distributed temperature in the well.

18. The system of claim 12, wherein the instrument detects Rayleigh backscattering.

19. The system of claim 12, wherein the instrument is operatively connected to at least one Bragg grating which detects the temperature or strain in the well.

20. The system of claim 12, wherein the instrument is operatively connected to at least one electronic sensor which detects the temperature or strain in the well.
